(19) United States
(12) Patent Application Publication
(10) Pub. No.: US 2010/0294166 A1
(43) Pub. Date: Nov. 25, 2010

(54) Oleaginous Corrosion-Resistant Coatings

(76) Inventor: El Sayed S. Arafat, Leonardtown, MD (US)

Correspondence Address: Department of the Navy;(Naval Air Warfare Center -Aircraft Division), 47076 Lijencreantz Road, B 435, PATUXENT RIVER, MD, 20670, US

(21) Appl. No.: 12/686,408

(22) Filed: Jan. 13, 2010

Related U.S. Application Data
(63) Continuation-in-part of application No. 11/264,336, filed on Oct. 27, 2005, now Pat. No. 7,776,233.

(51) Int. Cl. C09D 5/08

(52) U.S. Cl. 106/14.29; 106/14.42; 106/14.43

(57) ABSTRACT

The invention relates to an oleaginous corrosion-inhibiting coating composition, and the use of said coatings to protect metal from corrosion. The composition comprises, in parts by weight, from about 20 to 40 parts of lubricating oil, 10 to 40 parts of organic solvents, 10 to 30 parts of an inhibitor consisting of sulfonic acid-carboxylic acid metal complexes, effective amounts of at least two different oil soluble antioxidants, effective amounts of at least one water-displacing compound, 10 to 30 parts of at least one alkyl or alkylaryl metal sulfonate and 0.1 to 2.0 parts of at least one phosphoric acid ester and amine salt.

### RELATED U.S. APPLICATION DATA

This application is a continuation-in-part of copending application Ser. No. 11/264,336 Filed Oct. 27, 2005.

### ORIGIN OF INVENTION

The invention described herein was made by employee(s) of the United States Government and may be manufactured and used by or for the Government for governmental purposes without the payment of any royalties thereon or therefore.

### BACKGROUND OF THE INVENTION

1. Field of the Invention

This invention relates to coating compositions and to the method of using said compositions to prevent the corrosion of metal. More specifically, this invention relates to oleaginous coating compositions comprising mineral lubricating oils, organic solvents, corrosion inhibitors, rust preventive agents, antioxidants, metal deactivators and water-displacing agents. The oleaginous corrosion-resistant compositions of this invention are most useful as coating on various metal substrates including ferrous metal, aluminum, magnesium, ferrous alloy surfaces and are particularly useful as corrosion-inhibiting coatings for aircraft and automotive frames. For example, as aircraft age, corrosion often occurs in the internal structures which are not easily inspected or treated. Especially in harsh environments where humidity, salt and heat conspire to reduce metal parts to piles of oxide, fogging CPC's (Corrosion Preventative Compounds) into the internal spaces of airframes has been shown to be effective in combating metal degradation. However, the current CPC's must be reapplied several times annually, using time-consuming procedures. As an alternative to the current corrosion inhibitors, this invention provides high performance, long lasting, Corrosion Preventative Compounds (CPC's) for internal airframe applications to minimize the costs attributed to the aging aircraft.

2. Background

It is known that the corrosion of metallic structures has a significant impact on the U.S. Economy, including infrastructure, transportation, utilities, production and manufacturing, and government. Corrosion has become a very costly factor in the Department of Defense; many aircraft and defense equipment are becoming old and corrosion is becoming a life-limiting factor on some of these aircraft. As aircraft age, corrosion often occurs in internal structures which are not easily inspected or treated. One of the most effective ways to reduce the cost of corrosion maintenance is the use of corrosion preventative compounds (CPC) to protect metals from corrosion. However, the CPC must be reapplied several times annually, using time-consuming procedures. Existing CPC products require reapplication every 6-9 months, which results in an increase in the cost due to air pollution, maintenance, labor, down time, and the number of inspections. As an alternative, a high performance, long lasting, a corrosion preventative compound (CPCs) has been developed for aerospace applications to minimize the costs of corrosion maintenance.

CPC's are generally composed of a barrier film containing corrosion inhibitors, various other additives and sometimes a carrier solvent. Today, film-formers for CPC's include natural and synthetic oils, oxidized petroleum fractions and polymers, depending on the desired application and performance requirements. Mineral oil as well as wool wax have proven useful, but more recent developments involve the use of polymeric resins, including the acrylics, silicones, silicone alkyds, urethanes and other proprietary materials. Most of these film formers provide a physical barrier to the corrosive environment, but cannot prevent the slow diffusion of corrosive agents through the film. Some films, particularly the films containing the naturally derived materials, are not resistant to oxidation and require antioxidant additives to protect the film from degradation. In fact, without these and other additives, the barrier films often provide very poor corrosion-resistance. The blending of these additives in the film is usually the key to superior performance with minor differences in structure often producing major effects in staving off the corrosive attack of the environment.

Presently, corrosion preventative additives include not only anodic and cathodic inhibitors, but also acid acceptors and chelating agents. These agents provide a synergism with the film former that often produces outstanding corrosion protection. For example, magnesium, calcium and barium salts of sulfonic acids (such as the alkylbenzenesulfonates and dinonylnaphthalene sulfonates) are outstanding metal deactivators resulting from the strong adsorption of the sulfonate group. The non-polar portion of the molecule tends to shield the surface from ionic attack from various environmental species. Phosphate compounds also have been used, most recently, in a difunctional additive where the distance between the phosphate moieties was optimized for a particular resin system. In addition, vapor phase corrosion inhibitors (such as the dicyclohexylammonium compounds, various amines, and benzoates) also may be useful in CPC films especially for internal applications where near-stagnant atmospheres exist.

Many CPC's contain carrier solvents which require evaporation to deposit the protective film. However, the use of solvents is regulated in many locations either by content (e.g. grams per liter volatile organic compounds (VOC)) or by vapor pressure. In addition to the solvent limitations, some additives previously used for their exceptional performance (such as barium sulfonates) are cited because of their heavy metal content. Substitute vehicles (such as water-borne resins) and substitute additives (such as calcium sulfonates) are possible, but only when the critical properties of the CPC performance are well understood.

Moreover, the formulation of CPC's has limitations. Higher concentrations of many additives results in higher viscosities causing the products to suffer performance problems. Ineffective water-displacement, incomplete crevice penetration, and poor sprayability are some of the problems that sooner or later contribute to the CPC's failure. Another approach to applying more corrosion-preventing additives is to use products that dry to thicker films, however, thicker CPC's attract hygroscopic dust and dirt and add considerable weight to small aircraft which leads to maintenance problems such as the inability to inspect a surface. In addition, there are several failure mechanisms for CPC's. Hard films fail when thermal expansion, mechanical movement or fatigue causes cracking of the substrate. Soft films fail when water slowly permeates and dissolves or emulsifies the CPC. Slow diffusion of environmental corrodents through a film will sooner or later initiate corrosion, damaging the film and allowing more direct attack on the surrounding metal. Some films can flow sufficiently to heal themselves in spite of repeated physical film damage, however, this also means that flow occurs when there is no damage, resulting in decreasing film thickness and subsequent loss of their corrosion preventative properties. Further, some additives to the CPC's catalyze the hydrolysis of film formers which leads to porosity or even complete destruction of the film. Even atmospheric oxidation of the film or UV radiation induced failure can occur prior to the expected life of the film.

### SUMMARY OF THE INVENTION

This invention relates to oleaginous corrosion-resistant coating compositions and to the method of manufacturing and using said compositions to inhibit corrosion of various metal surfaces. The coating compositions comprises from about 20 to 40 parts by weight of at least one mineral lubricating oil, 10 to 40 parts by weight of at least one organic solvent, 10 to 30 parts by weight of an alkyl and/or alkylaryl sulfonate corrosion inhibitor, 10 to 30 parts by weight of a sulfonic acid-carboxylic acid complex, 0.1 to 2.0 parts by weight of at least two or more oil soluble organic antioxidants, 0.1 to 5.0 parts by weight of at least one water-displacing compound, and from 0.1 to 2.0 parts by weight of at least one phosphoric acid ester and/or phosphoric acid amine salt.

Therefore, it is an object of this invention to provide an oleaginous corrosion-resistant composition and a method of preparing and using the compositions to inhibit the corrosion of metal.

It is another object of this invention to provide an oleaginous corrosion-resistant composition as a liquid or semi-solid.

It is still another object of this invention to provide an oleaginous corrosion-inhibiting composition and a method of using the composition to form a coating on metal substrates.

### DETAILED DESCRIPTION OF THE INVENTION

This invention relates to an oleaginous corrosion-resistant coating composition and to the method of inhibiting the corrosion of various metal surfaces including metal such as aluminum, aluminum alloys, and various ferrous metals such as steel. The oleaginous compositions of this invention comprise, in parts by weight, from about 20 to 40 parts and preferably 25 to 35 parts of at least one lubricating oil including mineral oils such as the paraffinic and naphthenic oils, synthetic oils and mixtures thereof in any ratio, from about 10 to 40 parts and preferably about 15 to 35 parts of at least one organic solvent such as the petroleum distillates and various mixtures of these solvents in any ratio, from about 10 to 30 parts and preferably from 15 to 25 parts of an oil soluble corrosion inhibitor consisting of a sulfonic acid-carboxylic acid metal complex, from about 0.1 to 2.0 parts and preferable 0.5 to 1.0 part of at least two different oil soluble organic antioxidants, from about 0.1 to 5.0 parts and preferably 1.0 to 3.0 parts of a water-displacing compound including the aliphatic alcohols and glycols such as the C₁-C₈ aliphatic alcohols, glycol ethers, ether alcohols, glycols, alkoxy alcohols, and preferably the lower alkylene glycols, from 0.1 to 2.0 parts and preferably from about 0.5 to 1.5 parts of an oil soluble phosphoric acid compound selected from the group consisting of phosphoric acid esters, phosphoric acid amine salts and mixtures of said esters and amine salts, and 10 to 30 parts and preferably 15-25 parts of at least one alkyl or alkylaryl metal sulfonate.

More specifically, the lubricating oils include oils of lubricating viscosity. These oils include natural and synthetic lubricating oils and mixtures thereof, having various viscosities. Natural oils include the mineral lubricating oils such as the paraffinic and naphthenic oils or mixtures thereof. Natural base oils include mineral lubrication oils which may vary widely as to their crude source, e.g., as to whether the oils are paraffinic, naphthenic, or mixtures of paraffinic-naphthenic oils.

The compositions of the present invention include organic solvents. Generally, the solvent comprises 10-40 parts of the composition. In certain preferred embodiments, the solvents comprise at least 30% of the composition; and, in specific preferred embodiments, the solvent comprises 15-35 parts of the composition. The solvents are selected from the group consisting of esters, ketones, aldehydes and ethers. Specific solvents comprise alkyl acetate esters such as butyl acetates, and n-butyl acetate and t-butyl acetate. Other solvent materials comprise the ketones such as methyl ethyl ketone, methyl isobutyl ketone, acetone and the like. In many instances, commercial solvent mixtures such as the aromatic hydrocarbons can be used as the solvent. Preferred solvents include aromatic or aliphatic hydrocarbons. Aromatic solvents include benzene, toluene, xylenes, and aromatic fractions from distillation of petroleum. Aliphatic hydrocarbon solvents include hexane, cyclohexane, heptanes, octanes, and similar straight and branched hydrocarbons and mixtures thereof, generally having 4-16 carbon atoms. Also included are aliphatic fractions from distillation of petroleum including mineral spirits.

The corrosion inhibitors are derived from the reaction of at least one sulfonic acid such as an alkyl or alkylaryl sulfonic acid and at least one carboxylic acid and a metal compound to form a complex. The preferred corrosion inhibitors are derived from the stoichiometric reaction of a metal compound such as an alkaline earth metal with a sulfonic acid and a carboxylic acid preferably at least one or more of the fatty acids to form the metal complex. Sulfonic acids can have molecular weights in the range of 150-2,500 or greater, preferably 325 to 600 or greater. Suitable sulfonates are those having an alkyl group, e.g. alkylated benzene or alkylated naphthalene sulfonates. Examples of such sulfonic acids are dioctyl benzene sulfonic acid, didodecyl benzene sulfonic acid, dinonyl naphthalene sulfonic acid, diaryl benzene sulfonic acid, lauryl benzene sulfonic acid, alkylated benzene sulfonic acids such as polybutylene alkylated benzene sulfonic acid and polypropylene alkylated benzene sulfonic acid. Preferred as aromatic sulfonates in the practice of this invention are dinonylnapthalene sulfonates, nonylnaphthalene sulfonates, petroleum sulfonate, dodecabenzene sulfonates and the like.

A group of sulfonic acids are mono-, di- and tri-alkylated benzene and napthalene sulfonic acid. Illustrative of synthetically alkylated benzene and napthalene sulfonic acids are those containing alkyl substituents having about 30 carbon atoms, or from about 12 to 30 carbon atoms. Specific examples of sulfonic acids are mahogany sulfonic acids; alkylbenzene sulfonic acids (where the alkyl group has at least 10 carbons), dilaurybeta-naphtha sulfonic acids, and alkaryl sulfonic acids, such as dodecylbenzene sulfonic acid.

The sulfonates are salts of barium, calcium, magnesium, or a mixture of any of the foregoing. The metal sulfonates may be formed by methods known to those skilled in the art. The metal salts of aromatic sulfonic acids may be prepared by reacting an inorganic metal compound, e.g. metal hydroxide, metal oxide or metal carbonate with the alkyl or dialkyl or polyalkyl aromatic or alkyl sulfonic acid. For example, the reaction of any of barium hydroxide, calcium oxide, magnesium oxide, zinc hydroxide, and the like with the corresponding alkyl aryl sulfonic acid yields suitable metal sulfonates. Preferred sulfonates are barium, calcium, magnesium or zinc sulfonates such as barium dinonylnaphthalene sulfonate, calcium dinonylnaphthalene sulfonate, magnesium dinonylnaphthalene sulfonate, zinc dinonylnaphthalene sulfonate, barium alkylbenzene sulfonate, particularly calcium dodecylbenzene sulfonate, magnesium alkylbenzene sulfonate, magnesium dodecylbenzene sulfonate, zinc alkylbenzene sulfonate, particularly zinc dodecylbenzene sulfonate, or a mixture of any of these sulfonates. Preferred are barium dinonylnaphthalene sulfonate, calcium dinonylnapthalene sulfonate, magnesium dinonylnaphthalene sulfonate, and zinc dinonylnaphthalene sulfonate.

The carboxylic acids used in preparing the metal complexes include aliphatic, cycloaliphatic and aromatic mono- and poly carboxylic acids such as alkenyl-substituted cyclopentanoic acids, or the alkyl-substituted aromatic carboxylic acids. The aliphatic acids generally contain at least 6 and preferably at least 12-30 carbon atoms. The cycloaliphatic and aliphatic carboxylic acids can be saturated or unsaturated. Specific examples of the carboxylic acids include hexanoic acid, linolenic acid, substituted maleic acids, behenic acid, isostearic acid, capric acid, linoleic acid, lauric acid, oleic acid, ricinoleic acid, undecylic acid, myriatic acid, palmitic acid, and mixtures of two or more carboxylic acids and the like. The carboxy acids include the fatty acids having the formulas CₙH₂ₙ₊₁ COOH, CₙH₂ₙ₋₁ COOH or CₙH₂ₙ₋₃ COOH. The equivalent weight of these carboxylic acids is the molecular weight divided by the number of acid groups. In another embodiment, the carboxylic acids may be aliphatic or aromatic, mono- or polycarboxylic acids. These carboxylic acids include lower molecular weight carboxylic acids as well as higher molecular weight carboxylic acids.

Preferably, the sulfonate-carboxylate complexes are derived from alkaline earth metals compound such as calcium, barium or magnesium compounds. These metal neutralizing compounds include the metal oxides, hydroxides, carbonates, bicarbonates and mixtures thereof. These corrosion-resistant complexes are derived from the reaction of these metal compounds with stoichiometric amounts of the above recited sulfonic acids and the carboxylic acids to form the metal complex.

The oil soluble phosphates e.g. alkyl and/or aryl phosphates are derived from phosphoric acids forming the phosphoric acid mono- and diesters including the ammonium or amine salts of these acids including mixtures of phosphoric acid esters and amine salts. When the phosphorus acid esters are acidic, they may be reacted further with ammonia or amine to form the corresponding salt. The salts may be formed separately and then the salt of the phosphorus acid ester is added to the coating composition. Alternatively, the salts may be formed when the phosphorus acid ester is blended with other components to form the composition. The ammonium salts of the phosphorus acid esters may be formed from ammonia, or an amine, or mixtures thereof. These amines can be monoamines or polyamines. The monoamines generally have at least one group containing from 1 to 24 carbon atoms, with from 1 to 12 carbon atoms being preferred, with from 1 to 6 being more preferred.

At least two oil soluble antioxidants are added to the corrosion-resistant coating compositions in a total amount ranging from about 0.1 to 2.0 and preferably from 0.5 to 1.0 parts by weight or up to about 2.0% by weight of the composition. The preferred antioxidants are selected from the group consisting of the diphenylamines and derivatives there, alkylated diphenylamines, e.g. the C₁-C₁₀ alkalated phenylated amines, and phenylnapthylamines and the like. Other useful antioxidants include the oil soluble phenols, hindered bisphenols, sulfurized phenols, and the alkylated phenols including the arylalkyl phenols. Specific phenols include 2-t-butylphenol, 2-sec-butylphenol, 2-isopropylphenol, 2,6-diisopropylphenol, 2-t-octylphenol, 2-cyclopentylphenol, and mixtures thereof. The supplemental antioxidant includes a second but different antioxidant selected from the group consisting of diphenylamines, alkylated diphenylamines, phenyl-napthylamines, tert-butylphenols, sulfurized alkylphenols, and dithiocarbamates. It is believed that the use of a supplemental antioxidant is necessary and that a preferred composition of the present invention includes more than one but different antioxidants. In another embodiment, the lubricating compositions have at least about 1%, or about 1.5% by weight of a carbamate antioxidant, or mixture thereof, preferably with an amine antioxidant. In another embodiment, the antioxidant include amine antioxidants, phenol antioxidants, phosphite antioxidants, and mixtures thereof.

The water-displacing agents or compounds are added to the corrosion-resistant composition in amounts ranging from about 0.1 to 5.0 parts and preferably in amounts of 1.0 to 3.0 parts. These water-displacing agents include the alkoxyalcohols or aliphatic alcohols, ethers, ether alcohols, alkylene glycols such as ethylene glycol, diethylene glycol, 2-butoxyethanol, 2-methyl-2,4-pentanediol, hexylene glycol, glycol ethers, alkylene glycol ethers and mixtures thereof. The primary alcohols include n-butyl alcohol, isobutyl alcohol, n-amyl alcohol, isoamyl alcohol, n-hexyl alcohol, 2-ethyl-1-hexyl alcohol, isooctyl alcohol, nonyl alcohol, decyl alcohol, dodecyl alcohol, tridecyl alcohol, etc.

The following Examples illustrate the oleaginous corrosion-resistant coating compositions of this invention.

### Example 1

| | Parts by Weight |
|---|---|
| Mineral Oil | 20-40 |
| Sulfonic acid-carboxylic acid metal complex | 10-30 |
| Organic solvent (aliphatic hydrocarbons) | 10-40 |
| Water-displacing agent (alkylene glycol) | 0.1-5.0 |
| Antioxidants (diphenylamines) | 0.1-2.0 |
| Alkyl and alkylaryl sulfonates | 10-30 |
| Phosphoric acid esters and amine salts | 0.1-2.0 |

### Example 2

| | Parts by Weight |
|---|---|
| Mineral Oils (paraffinic and naphthenic oils) | 25-35 |
| Organic solvents | 15-35 |
| Corrosion Inhibitor (sulfonic acid-carboxylic | 15-25 |
| acid metal complex) | |
| Antioxidant (diphenylamines) | 0.5-1.5 |
| Water-displacing agent (hexylene glycol) | 1.0-3.0 |
| Alkyl and alkylaryl sulfonates | 15-25 |
| Phosphoric acid esters and amine salts | 0.5-1.5 |

### Example 3

| | Parts |
|---|---|
| | by Weight |
| Lubricating oils (naphthenic and paraffinic mineral oils) | 20-40 |
| Organic solvents (petroleum distillates and aliphatic | 15-35 |
| hydrocarbons) | |
| Corrosion inhibitors (sulfonic acid-carboxylic acid metal | 18-22 |
| complexes) | |
| Antioxidants (diphenylamines, phenols | 0.5-1.0 |
| Water-displacing compounds (alkylene glycols) | 1.5-2.5 |
| Alkyl and alkylaryl sulfonates | 18-22 |
| Phosphoric acid esters and/or amine salts | 0.8-1.2 |

Table I shows the test results of the coatings of this invention:

TABLE 1
TEST RESULTS
REQUIREMENTS FOR TYPE II, CLASS 1

| | Requirements | Test | |
|---|---|---|---|
| Property | (Type II Class 1) | Para. | TEST RESULTS |
| Acid salt fog | Not visible corrosion (no more | 4.6.1 | Carbon Steel after 2 cycles: |
| protection | than three rust spots less than 1 mm | | No visible corrosion |
| | in diameter) on carbon steel | | Conforms |
| | after 2 cycles | | |
| Application | Brush, Dip or Spray | 4.6.2 | Compound sprayed satisfactorily; |
| | | | no froth, bubbling or excessive runoff; |
| | | | readily wet the surfaces of test panels |
| | | | Conforms |
| Compatibility with | No sedimentation of | 4.6.3 | MIL-PRF-32033: No sedimentation or |
| MIL-PRF-32033 & | separation | | evidence of chemical precipitation or reaction |
| MIL-L-87177 | | | Conforms |
| Compatibility with | No cracking or degradation of | 4.6.4 | Polyimide Wire (MIL-W-81381/11): |
| polyimide, | insulation following | | No cracking or degradation of |
| polyalkane, PVC & | prolonged exposure; | | insulation; No dielectric leakage |
| PTFE wiring | No dielectric leakage | | Conforms |
| insulation | | | Polyalkene Wire (MIL-W-81044): |
| | | | Not performed (wire not available) |
| | | | PVC Wire (MIL-W-5086): No |
| | | | cracking or degradation of insulation; |
| | | | No dielectric leakage Conforms |
| | | | PTFE (MIL-W_81822/6): Not |
| | | | performed (wire not available) |
| Corrosivity, max. | 0.5 mg/cm2 | 4.6.5 | Magnesium (AMS 4375): <0.1 mg/cm² |
| weight change | 0.2 mg/cm2 | | Cadmium (A-A-51126): <0.1 mg/cm² |
| Mag, Cad, Zinc Al, | | | Zinc (MIL-A-18001): <0.1 mg/cm² |
| Copper, Brass | | | Aluminum (QQ-A-250/4): <0.1 mg/cm² |
| | | | Copper (ASTM B 152): <0.1 mg/cm² |
| | | | Brass (AST, B 36): <0.1 mg/cm² |
| | | | Conforms |
| Dielectric strength | 25,000 volts minimum | 4.6.7.1 | Greater than 35,000 volts |
| | | | Conforms |
| Effect on acrylic | No cracking, crackling, or | 4.6.6 | MIL-PRF-5424 (Type A acrylic): |
| plastic and | staining | | No visible cracking, crazing or staining |
| polycarbonate | | | AMS-P-83310 (polycarbonate): |
| | | | No visible cracking, crazing or staining |
| | | | Conforms |
| Effect on electronic | Not applicable for Type II | 4.6.7 | Not applicable for Type II |
| components | | | |
| Effect on urethane | No cracking, crackling, or | 4.6.8 | Paint system MIL-PRF-23377/MIL- |
| paint | staining | | PRF-85285 <1 pencil hardness change |
| | | | after 24 hours; No crazing, crackling or |
| | | | staining; No streaking, discoloration or |
| | | | blistering Conforms |
| Fill weight, min. | Not applicable for Class 1 | 4.6.9 | Not applicable for Class 1 |
| Film appearance | Uniform and light brown or | 4.6.10 | Uniform and light brown or lighter; |
| | lighter; Simulated corrosion | | Simulated corrosion spots visible by |
| | spots shall be visible by unaided | | unaided eye Conforms |
| | eye | | |
| Film thickness, max. | 0.5 mil | 4.6.11 | Assuming density of NVM = 0.80 g/ml. |
| | | | Film Thickness = 0.5 mil Conforms |
| Flame projection | Not applicable for Class 1 | 4.6.22 | Not applicable for Class 1 |
| Flash point | Minimum, 140° F. | 4.6.23 | No flash observed to 141° F. |
| | | | Conforms |
| Friction coefficient, | 0.20 | 4.6.12 | Friction coefficient = 0.16 |
| max. | | | Conforms |
| Functional | No panel faying surface area to | 4.6.13 | Panel 1: Greater than 85% wetted |
| Penetration | be less than 80% wetted in 24 | | Panel 2: Greater than 85% wetted |
| | hours. Average of 3 panels to | | Panel 3: Greater than 85% wetted |
| | be 85% or better, wetted in 24 | | Average of 3 panels: greater than 85% wetted |
| | hours. | | Conforms |
| Hydrogen | No embrittlement of cadmium | 4.6.24 | Specimens: ASTM F519, Type 1c, |
| embrittlement | plated 4340 steel in accordance | | cadmium plated La.w. MIL-STD-870 |
| | with SAE-AMS-S-5000 | | Type I 45% load, 150 hour exposure |
| | | | Specimens 1, 2, 3, 4: No failures |
| | | | Conforms |
| Leakage/ | Not applicable for Class 1 | 4.6.14 | Not applicable for Class 1 |
| distortion of cans | | | |
| Net content of | Not applicable for Class 1 | 4.6.21 | Not applicable for Class 1 |
| container | | | |
| Neutral salt fog | 336 hours | 4.6.15 | No visible corrosion after 336 hours |
| protection, min hrs to | | | Conforms |
| unacceptable | | | |
| corrosion | | | |
| Non-volatile content | Report | 4.6.16 | Non-volatile content: 70.6% |
| | | | Informational |
| Performance of self- | Not applicable for Class 1 | 4.6.17 | Not applicable for Class 1 |
| pressurized | | | |
| container | | | |
| Removability | Completely removable | 4.6.18 | Completely removable with |
| | with MIL- | | MIL-PRF-680 Type II |
| | PRF-680 Type II or MIL- | | Conforms |
| | PRF-85570 Type II | | |
| Storage stability, | Meet all specification | 4.6.19 | Not performed |
| min. | requirements for 2 years | | |
| | after manufacture date. | | |
| Water displacement | No visible corrosion | 4.6.20 | No visible corrosion |
| | | | Conforms |

For coating automotive or aircraft frames and the like, a solid “hot melt” composition is particularly suitable. For corrosion-inhibiting purposes, the thickened composition of this invention may be applied to the metal surface by methods including brushing, spraying, dip-coating, flow-coating, roller-coating and the like. The viscosity of a thickened composition may be adjusted for the particular method of application by adding an inert organic solvent. The coated metal surface may be dried by exposure to air or baking. If the coating composition is of correct viscosity, the coating or film can be applied directly to the metal surface and the solvent and drying may not be necessary. The film thickness is not critical, however, a coating ranging up to about 5,000 mg or more per square foot for coatings of aircraft frames or other structural members is sufficient to provide adequate protection.

While this invention has been described by a number of specific examples, it is obvious to one skilled in the art that there are other variations and modifications which can be made without departing from the spirit and scope of the invention as particularly set forth in the appended claims.

The invention claimed:

1. An oleaginous corrosion-inhibiting coating comprising, in parts by weight, from about 20 to 40 parts of a lubricating oil, 10 to 30 parts of a sulfonic acid-carboxylic acid complex, 10 to 30 parts of at least one alkyl or alkyl aryl metal sulfonate, 10-40 parts of at least one oil soluble organic solvent, 0.1 to 5.0 parts of at least one water-displacing compound, 0.1 to 2.0 parts of at least two different oil soluble organic antioxidants, and 0.5 to 2.0 parts of at least one phosphoric acid compound selected from the group consisting of phosphoric acid esters, phosphoric acid amine salts and mixtures of said phosphoric acid esters and amine salts.

2. The coating of claim 1 wherein the solvent is a mixture of two different oil-soluble organic solvents.

3. The coating of claim 1 wherein the phosphoric acid compound is a mixture of phosphoric acid esters and amine salts.

4. The composition of claim 1 wherein the lubricating oil is a mixture of mineral oils and synthetic oils.

5. The composition of claim 1 wherein the lubricating oil is a naphthenic or paraffinic oil of mixture thereof.

6. The composition of claim 1 wherein the solvent is a mixture of aliphatic and aromatic organic solvents.

7. The composition of claim 6 wherein the solvent is a mixture of petroleum distillates and aliphatic hydrocarbons.

8. The composition of claim 1 wherein the complex is a sulfonic acid-carboxylic acid alkaline earth metal complex.

9. The composition of claim 8 wherein the sulfonic acid-carboxylic acid metal complex is derived from fatty acids and alkyl sulfonic acids.

10. The composition of claim 9 wherein the sulfonic acid-carboxylic acid metal complex is derived from an alkyl sulfonic acid and a mixture of fatty acids.

11. The composition of claim 1 wherein the lubricating oil is a naphthenic or paraffinic oil and the solvent is a mixture of petroleum distilates and aliphatic hydrocarbons.

12. The composition of claim 1 wherein the sulfonic acid-carboxylic acid metal complex ranges from about 15 to 25 parts by weight, the solvent ranges from about 15 to 35 parts by weight, and the lubricating oils range from about 25 to 35 parts by weight.

13. The composition of claim 11 wherein the metal complex is an alkaline earth metal complex.

14. The composition of claim 1 wherein the water-displacing compound is selected from the group consisting of glycols, glycol ethers, aliphatic alcohols, ethers, ether alcohols, alkylene glycols, alkoxy alcohols, and mixtures thereof in any ratio.

15. The composition of claim 14 wherein the water displacing compounds are alkylene glycols or aliphatic alcohols.

16. The composition of claim 15 wherein the water-displacing compound is hexylene glycol.

17. The composition of claim 15 wherein the water-displacing compounds are lower molecular weight alcohols.

18. The composition of claim 1 wherein the sulfonic acid-carboxylic acid metal complex is derived from alkylaryl sulfonates, lower molecular weight fatty acids and alkaline earth metal compounds thereof.

19. The composition of claim 18 wherein the metal complex is derived from alkaline earth metal compounds and mixtures of fatty acids.

20. A process for inhibiting the corrosion of metal surfaces which comprises coating the metal surfaces with an effective amount of an oleaginous corrosion-resistant coating composition comprising, in parts by weight, from about 20 to 40 parts of lubricating oil, about 10 to 40 parts of at least one organic solvent, about 10 to 30 parts of a sulfonic acid-carboxylic acid metal complex, from about 0.1 to 2.0 parts of at least two different oil soluble organic antioxidants, and from about 0.1 to 5.0 parts of at least one water-displacing compound, from about 10 to 30 parts of at least one alkyl or alkylaryl metal sulfonate and 0.1 to 2.0 parts of a phosphoric acid ester and/or phosphoric acid amine salt.

21. The process of claim 20 wherein the lubricating oil is a mixture of mineral oils and synthetic oils.

22. The process of claim 20 wherein the solvent is a mixture of petroleum distillates and aliphatic hydrocarbons.

23. The process of claim 20 wherein the corrosion inhibitor is a sulfonic acid-carboxylic acid alkaline earth metal complex.

24. The process of claim 20 wherein the sulfonic acid-carboxylic acid metal complex is derived from mixtures of fatty acids.

25. The process of claim 20 wherein the water-displacing compound is selected from the group consisting of glycols, glycol ethers, aliphatic alcohols, ethers, ether alcohol, alkoxy alcohols, alkylene glycols and mixtures thereof in any ratio.

26. The process of claim 25 wherein the water-displacing compound comprises alkylene glycols.

27. The process of claim 20 wherein at least one antioxidant is a diphenylamine.
